(19) United States
(12) Patent Application Publication
(10) Pub. No.: US 2004/0010452 A1
(43) Pub. Date: Jan. 15, 2004

(54) Agent controlled commission system

(76) Inventor: Jude LaCour, Ormond Beach, FL (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 10/196,516

(22) Filed: Jul. 15, 2002

(51) Int. Cl. G06F 17/60

(52) U.S. Cl. 705/26

(57) ABSTRACT

The present invention comprises a system in which agents establish their own prices for goods and services and a principal pays commissions automatically based on the agent-established prices. The system is preferably implemented over the Internet, in which the principal operates a server for the purpose of evaluating purchases, determining commissions, and processing orders. One or more agents sell goods and services via tailored Internet sites, and can each adjust their prices independently. At various times, the principal pays the applicable commissions, determining the commissions for each agent based upon their separately-established pricing.

### FIELD OF THE INVENTION

This invention relates generally to systems in which agents establish their own prices for goods and services and a principal pays commissions automatically based on the agent-established prices.

### BACKGROUND OF THE INVENTION

There are a wide array of commission sales systems used to sell goods and services. Typically under a commission sales system agents sell goods or services and retain a portion of the purchase price as a commission. In many instances, the purchase price, and therefore the commission, is fixed. Occasionally bonuses are paid for sales in excess of a specified volume or to reward other performances.

Under some commission systems, an agent may negotiate the price with the buyer. In doing so, the agent is generally affecting the commission to be paid. If the agent negotiates a high price, a high commission is paid. On the other hand, if the price is severely discounted, the commission may be quite small. The discount that comes out of the commission in such cases must be determined by hand, on a case by case basis. Consequently, commission sales systems in which prices may be negotiated do not lend themselves to high volume and low price operations, but rather are most suited for big ticket items such as automobile or home sales.

In at least one case, a multi-level marketing system has been automated. For example, in U.S. Pat. No. 6,134,533 to Shell, a server integrates the collection of a payment over a network, distributes the product, and calculates commissions using a multi-level marketing structure. Although Shell determines commissions as a function of the sales volume and location on the multi-level marketing structure, there is no suggestion in Shell that the system allows agents to set their own fees, nor that the system is able to determine commissions based on different prices set by multiple agents for the same goods or services.

Accordingly, there is a need for a system and method that allows agents to set their own prices for goods and services, to automatically receive accurate commission payments based on those tailored prices, and that overcomes some of the above problems.

### SUMMARY OF THE INVENTION

The present invention comprises a system in which agents establish their own prices for goods and services and a principal pays commissions automatically based on the agent-established prices.

In accordance with further preferred aspects of the invention, a server is coupled to a network which is preferably the Internet. The server includes an associated memory and stored programming instructions, which preferably comprise Web pages.

In accordance with other aspects of the invention, any number of agent computers connected to the network can access the server. The agent computers are used by agents to access the server and, in some instances to develop, revise, and manage agent web sites.

In accordance with still further preferred aspects of the invention, any number of client computers are configured to access the agent computers. The client computers are used by customers to place orders for the goods and services offered for sale by the agents. In the preferred form, the customer communicates with the agent by using a customer computer to view an agent website. The customer client computer may take any form, including a desktop or notebook computer, a personal digital assistant, a cellular phone, or any other microprocessor-based devices.

In accordance with yet other preferred aspects of the invention, each agent establishes a tailored website offering goods or services that are ultimately provided by a principal. The agents are able to establish individual prices for the goods and services, and to advertise those self-established prices on the tailored websites.

In accordance with still another preferred aspect of the invention, customers access the agent websites to purchase goods or services. The agent websites collect payment information and forward the purchase request to the principal server for processing. The principal server processes the order by collecting payment, shipping the order, and calculating the applicable commission.

In accordance with still further aspects of the invention, the server determines the commissions to be paid as a function of a base price and the individual price set by each agent.

Accordingly, the system allows agents to establish individual prices for any number of goods or services, and automatically calculates the appropriate commissions earned for the sale of those goods or services.

### BRIEF DESCRIPTION OF THE DRAWINGS

The preferred and alternative embodiments of the present invention are described in detail below with reference to the following drawings.

FIG. 1 is a block diagram of a preferred agent controlled commission system;

FIG. 2 is a block diagram of a server and associated databases for a preferred agent controlled commission system;

FIG. 3 is a block diagram of the process flow of a preferred agent control commission system;

FIG. 4 is a flow diagram of the process of enlisting agents and soliciting orders within a preferred agent controlled commission system; and

FIG. 5 is a flow diagram of the process of receiving and processing orders and commissions within a preferred agent controlled commission system.

### DETAILED DESCRIPTION OF THE PREFERRED EMBODIMENT

This agent controlled commission system is ideally suited for an environment in which a number of persons or entities sell goods and are paid commissions for those sales. Although a variety of structures are possible, the description of the preferred embodiment uses a model in which a “principal” is the supplier of the goods or services that are sold by “agents.” The principal need not be the manufacture or even the shipper of the goods, but rather is the entity that the agents turn to for shipping, payment, and other aspects of order processing. Thus, for example, the principal may be a manufacturer, manufacturer's representative, authorized reseller, distributor, or an entity one or more levels higher than an agent in a multi-level marketing structure. In some cases, the principal itself may be paid commissions from a higher-level entity for the sales of its agents. The “agent” is an individual or other entity engaged to sell goods or services for the principal in exchange for a commission.

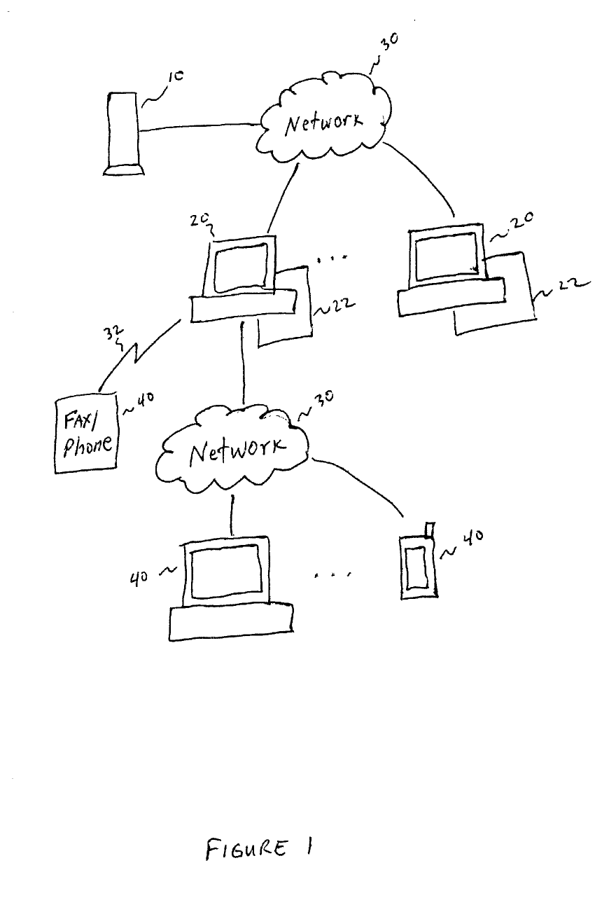

A preferred agent controlled commission system is illustrated in FIG. 1. The system includes a server 10 accessible over a network 30. The server can comprise any computer-based system, and is preferably configured to operate, or host, one or more Web pages accessible over the network 30. In this regard, while the principal is described as operating a “server,” the actual hardware used by the principal need not be a server in the traditional sense, but rather may be any microprocessor-based device. The network 30 is preferably the Internet, although it could alternatively be any wired or wireless communication channel.

A plurality of agent computers 20 are also configured for communication over the network 30, and therefore able to access the server 10. Although two agent computers 20 are illustrated, any number of agent computers are possible. The agent computers 20 are preferably desktop or laptop computers having a processor, display, memory, input/output devices, and other typical components. Alternatively, the agent computers 20 may comprise any wired or wireless microprocessor-based device such as a personal digital assistant, pager, cellular telephone, or other devices adapted to communicate over the network 30.

The actual hardware requirements for the agents may vary widely. Primarily, the agent requires a system sufficient to enable communication with the server 10 operated by the principal. Preferably, each agent will have an agent computer system 20 as described above for the purpose of accessing the principal server 10. On the other hand, it may be possible for agents to directly use the principal server 10, avoiding the need for the agent computers 20 altogether.

The agents also require a system to offer goods and services for sale. As indicated in FIG. 1, each agent preferably has a website 22 used by the agent to offer goods and services. The agent websites 22 are preferably tailored for each individual agent, offering a different mix of goods and services and different prices for those goods and services. The website used by each agent to offer goods or services may be physically hosted on the principal server 10, the agent computer 20, or any third party server. For simplicity, the preferred embodiment presumes that the agent website is hosted on the agent computer 20. Regardless of where the agent websites are physically hosted, they may have Uniform Resource Locators (URLs) that share a common second level domain with the principal or that are completely different, whichever is desired.

Potential customers may access any of the agent websites 22 via any of a variety of customer ordering devices 40. As illustrated in FIG. 1, the customer ordering devices may comprise a computer, personal digital assistant, or other microprocessor based device configured to access the agent websites 22 over the network 30. Likewise, the customer ordering device 40 may comprise a telephone or facsimile machine operating wirelessly or over standard phone lines 32 to place orders. Although FIG. 1 illustrates customers accessing agent computers and agent websites, as discussed above the customers may alternatively access the principal server 10 directly in response to sales inquiries generated by the agents.

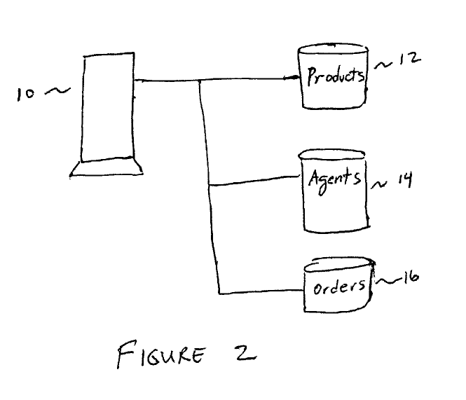

FIG. 2 illustrates the principal server 10 and its associated databases. In the preferred embodiment, the principal server is associated with three databases, including a products database 12, an agents database 14, and an orders database 16. These databases may be formed in a variety of ways, and may be sufficiently integrated so that they essentially form a single database.

The products database 12 includes each of the goods and services offered by the principal, as well as the cost of those goods and services. Each good or service offered by the principal will have corresponding data sufficient to allow the system to establish the commission structure for the applicable good or service. Depending on the objectives of the principal, the pricing information may comprise a floor price below which no commissions are paid, a minimum commission price, and a formula for associating commissions earned for selling goods or services above the floor or minimum prices. Although a formulaic approach is preferred because it allows any price to be set, the commissions may also be determined using a lookup table associating prices with commissions to be paid. Accordingly, the products database may contain a lookup table rather than a commission formula.

As an example, the products database may contain data related to a product having a floor price of $10. Below that price, the principal will not ship the product and will not pay commissions. Commissions are paid to the agent for all sales above that price, at the rate of five percent of the amount of the sales price in excess of $10. Alternatively, the principal may prefer to employ a minimum commission price, rather than a floor. Thus, the product database may indicate that the minimum commission price for a product is $12. If sold at that price, the agent receives a commission of $2. The database also indicates that an additional commission of 5% of the amount by which the purchase price that exceeds $12 is paid to the agent. Thus, the product database includes information related to each product, its floor or minimum price, and the relationship between the price paid by a customer and the commission to be paid to the agent. The actual relationships used may be much more complex, and need not necessarily related to a floor or minimum price.

Note that the floor or minimum price need not be separate data within the database, but rather may be maintained within the commission formula. For example, rather than storing a floor price of $10, the database may reflect a commission formula of COMMISSION=5%×(SALES PRICE−$10). In this manner, the database contains information related to the floor or minimum commission price, though not as a discrete entry.

The agents database 14 contains data related to the various agents. For example, it indicates the names and contact information for each agent. It also preferably includes the prices established by each agent for the goods or services offered by those agents on the applicable agent websites 22. In the preferred embodiment, the agents access the principal server 10 via the principal website to adjust the data stored in the agents database 14. After entering an appropriate username and password to access a management backend, the agents are able to select goods and services to offer and establish prices for those goods. Alternatively, pricing information may be set by sending an email from the agent computer 20 to the principal server 10, or by any other means. The principal server 10 confirms that those prices are acceptable by comparing them with floor or minimum commission prices, then either automatically updates or approves the updating of the agent websites 22 to reflect those prices.

The orders database 16 contains information related to orders received and processed by the server 10. As each order is received by the server, an entry is added to the orders database indicating the product sold, relevant customer information, the agent responsible for the sale, and the price at which the products were sold. The server is later able to use this information to determine the commissions to be paid to the agent responsible for the sale. In addition to price and quantity information, the orders database 16 may also include information related to customer returns, credit card declines, or other events affecting commissions.

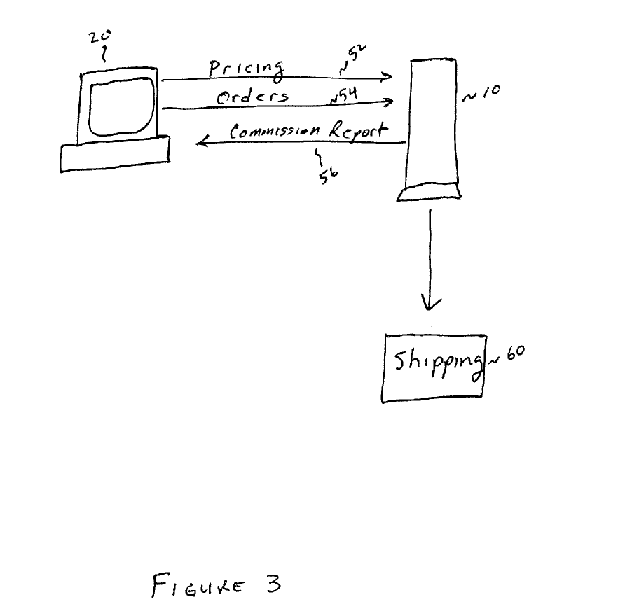

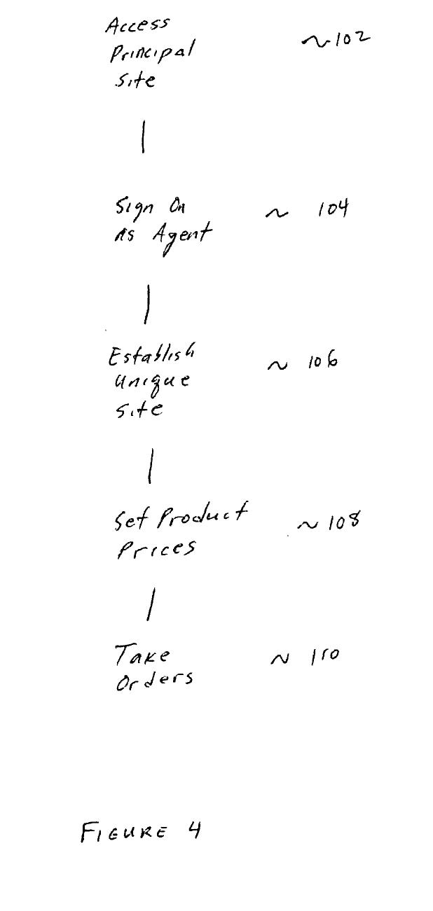

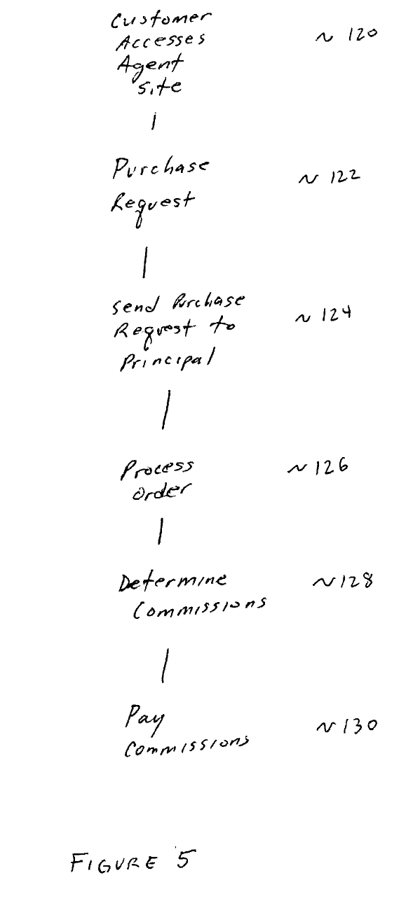

FIG. 3 illustrates the information flow for processing orders over the agent controlled commission system. As will be discussed in greater detail below with respect to FIGS. 4 and 5, the agent accesses the agent computer 20 to submit pricing information 52 to the principal server 10. Customers purchase products by ordering them at the agent websites 22, which transmit the purchase orders 54 to the principal server 10. The principal server 10 processes the orders, submitting a request to the shipping department 60 or other entity, as appropriate. At various times, the principal server 10 submits a commission report 56 to the agent computer 20, preferably via email. The actual commission payment is sent electronically or by mail.

FIG. 4 illustrates a flow diagram of the process of enlisting agents and soliciting orders within a preferred agent controlled commission system. Preferably, agents are enrolled over the network 30 by initially accessing the principal's website. At a first block 102, the prospective agent uses an agent computer 20 to access the principal server by entering the appropriate URL associated with the principal's website into a web browser. The principal's website contains information regarding the various terms and conditions for becoming an agent, as well as enrollment forms or other means for providing identification and contact information for the prospective agent. Once the agent has provided the required information and indicated agreement to the terms and conditions, the agent is enrolled, block 104. At the time of enrollment, the server provides a username and password to be used by the agent for future operations. Although the above enrollment process is preferably conducted over the network, it may also be performed in person, by telephone, by facsimile, or other means.

After enrolling as an agent, the agent establishes a tailored website for selling goods or services, block 106. In this sense, “tailored” does not necessarily mean that the website differs greatly or even at all from other agents. Rather, it means that a particular website is created for each agent. In most cases, agents will develop different websites having different product mixes and prices, but significant variation is not necessarily required. In some instances, the agent websites will have similar products and pricing but a different look and feel graphically.

The website that is developed for each agent may be established in a variety of ways. In some cases, agents may already have existing sites. If so, those sites may merely be revised as appropriate to reflect any changes in product offerings and to ensure that customer orders are properly sent to the principal for fulfillment.

For those agents without existing websites, the principal will develop a tailored site. Using the product mix and pricing requested by the agent at the time of enrollment, the principal server 10 automatically generates one or more web pages for use by the agent. If the agent has previously obtained a URL and a physical host or IP address, the agent provides that information at the time of enrollment so that the tailored website may be automatically loaded. If the agent has neither a URL nor a physical host, the server 10 may generate a URL and also host the agent website 22 that it develops. At that point, the agent will have an operational website containing the requested product mix and pricing, including pages from which customers may order products. Purchase orders are automatically sent to the principal server 10 for processing.

At any time after enrollment, the agent may adjust its prices, block 108. As discussed above, product prices may be adjusted by logging onto the principal website, entering a username and password, and then accessing appropriate backend web pages for adjustment of prices recorded in the agents database 14. Though preferably set by accessing the principal's website, prices may also be adjusted by sending an email, fax, or by telephone communication with the principal. After the agent requests a pricing change in any of the above forms, the requested prices are evaluated for compliance with required minimum pricing or other aspects. Once approved, the principal either authorizes the agent to modify its website or the principal modifies the agent website and uploads the new HTML or other code to the host.

The modification of the client website may be fully automated by the principal. In such an embodiment, the principal server 10 compares the requested pricing with minimum pricing established by the principal. If it is acceptable, the principal server accesses the stored website software for the applicable agent and modifies the stored prices to reflect the change. It then automatically uploads the modified code to the website host to complete the change. The same routine may be used for adding or deleting products.

At any point when the agent website 22 is live, customers may purchase products, block 110. In the preferred embodiment, customer purchases occur over the Internet, although they may also take place via telephone, facsimile, or other means.

The customer order and commission calculation process is illustrated more fully in FIG. 5. At a first block 120, customers access the agent website 22. At that point, prospective customers review the various goods and services offered and decide whether to make a purchase.

Once a customer decides to purchase a product, a purchase request is made, block 122. The purchase request can take a variety of forms, but preferably follows a shopping cart model commonly used with Internet shopping sites. Thus, one or more HTML pages solicit the customer's name, address, telephone number, or any other details pertinent to ordering and shipping. The agent website also requests a credit card number and expiration date for payment purposes.

Preferably, the agent website 22 includes a subroutine to request prompt approval of the credit card purchase from an appropriate credit card company or approval agency. Likewise, the credit card is promptly billed the amount of the purchase price and the customer is given an order confirmation. The confirmation can be in the form of an HTML page sent to the customer computer 40, an email sent to an email address provided by the customer, or any other form.

Once the customer purchase request has been completed and approved, it is sent to the principal 124. Note that approval is preferably obtained while the order is under the control of the agent, but order approval can alternatively be accomplished by the principal. For example, when the customer purchase request is made, block 122, a subroutine operating on the agent computer 20 transfers the customer identification and credit card information to the principal server 10 to gain order approval. Alternatively, the order approval may be omitted entirely or may be obtained after the purchase request is sent to the principal. Depending on the timing and degree of approval, the order confirmation given to the customer may contain an indication stating whether the order has been approved or whether it is merely in process pending proper approval.

The principal then processes the order, block 126. Actual order processing can vary widely depending on the nature of the goods or services being sold. As an example, the principal may simply send the product to the customer at the shipping address and collect the payment from the credit card company. Shipment and payment may occur in a variety of forms, however, involving any number of other parties.

At various times, the principal server 10 determines the amount of commissions owed to its agents. The determination can be at any time and any frequency, including, for example, annually, quarterly, monthly, or daily. Because the system is automated, commissions may also be paid contemporaneously upon order receipt, approval, shipping, or other milestones.

The calculation of commissions is based on the pricing for each agent as stored in the agent database, as well as the number of products purchased in the relevant period, less any returns or other applicable deductions. Although the preferred embodiment employs an agents database of stored prices for each product, the commissions calculation may be implemented differently. For example, the agents may simply establish their own prices and post them on their websites without prior approval of those prices by the principal. The agents then take orders from customers and submit them to the principal for fulfillment, as generally described above. In this form, however, the order approval process also includes a price evaluation by the principal. Thus, in addition to gaining credit card approval, the principal determines whether the price is acceptable. While this form is possible consistent with this invention, it is less desirable because it potentially allows prices to be advertised and customers to make purchase offers for products that the principal is unwilling to sell at that price.

Finally, after commissions have been determined the principal pays the commissions and sends a commission report to the agents, block 130. As noted above, the frequency of the commissions and reports may vary, as desired. Likewise, the payment of commissions and the commission reports need not coincide and may have different frequencies.

While the preferred embodiment of the invention has been illustrated and described, as noted above, many changes can be made without departing from the spirit and scope of the invention. Accordingly, the scope of the invention is not limited by the disclosure of the preferred embodiment.

I claim:

1. A system for determining commissions earned by an agent, the system comprising:
a server configured for communication over a network; and
a memory associated with the server, the memory containing a relationship between purchase prices and commissions earned for a sale of one or more goods or services;
the memory further containing stored programming instructions that, when executed by the server, cause the server to determine the commissions earned by the agent.

2. The system of claim 1, further comprising a plurality of agents and wherein the stored programming instructions, when executed by the server, cause the server to determine the commissions earned by each of the plurality of agents.

3. The system of claim 2, wherein the plurality of agents are able to adjust the prices for the goods or services, and further wherein the stored programming instructions, when executed by the server, cause the server to determine the commissions earned by each of the plurality of agents as a function of the adjusted prices and the stored relationship.

4. The system of claim 3, wherein the memory contains prices at which each of the agents is offering for sale the goods or services.

5. The system of claim 4, wherein relationship between purchase prices and commissions earned is based upon a minimum purchase price.

6. The system of claim 5, wherein the memory further comprises stored programming instructions that, when executed by the server, cause the server to determine whether an agent-requested purchase price is above the minimum purchase price, and, if so, to store the agent-requested purchase price in the memory.

7. A method for processing orders by a principal for goods or services sold by an agent in an agent-controlled commission system, the method comprising:
establishing a relationship between a purchase price and commissions earned;
receiving a request from the agent to sell the goods or services at particular prices;
evaluating the request and, if acceptable, approving the request; and
determining the commissions earned for goods or services sold at the particular prices.

8. The method of claim 7, further comprising paying the commissions.

9. The method of claim 8, further comprising submitting a commission report to the agent.

10. The method of claim 9 further comprising storing the particular prices in a database.

11. The method of claim 10, further comprising processing orders received from the agent.

12. The method of claim 11, wherein processing orders further comprises obtaining payment and shipping information.

13. The method of claim 11, wherein processing orders further comprises obtaining credit card approval from a third party.

14. The method of claim 11, wherein processing orders further comprises shipping the goods or performing the services.

15. The method of claim 11, wherein determining commissions earned is based upon a minimum price established by the principal.

16. The method of claim 11, wherein the orders are received by the principal over a network.

17. A system for determining commissions earned by an agent, the system comprising:
a server configured for communication over a network;
a memory associated with the server, the memory containing a relationship between purchase prices and commissions earned for a sale of one or more goods or services;
a means for determining commissions earned by the agent based on the stored relationship.

19. The system of claim 18, further comprising a means for receiving requests by the agent to adjust the purchase prices.

20. The system of claim 19, further comprising a means for evaluating whether the requests to adjust the purchase prices are acceptable.
